(19) United States
(12) Patent Application Publication
(10) Pub. No.: US 2010/0011196 A1
(43) Pub. Date: Jan. 14, 2010

(54) Method and program network for exception handling

(76) Inventor: Thilo Opaterny, Nurnberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/499,844

(22) Filed: Jul. 9, 2009

(30) Foreign Application Priority Data
Jul. 10, 2008 (EP) 08012544.6

(51) Int. Cl. G06F 9/44; G06F 9/30

(52) U.S. Cl. 712/244; 717/125; 712/E09.016

(57) ABSTRACT

A method and a program network for exception handling are described. At least one error program element including an input and an output and an item of exception information stored for exception handling in the form of a data structure are defined in a graphical programming language.

### CROSS REFERENCE TO RELATED APPLICATIONS

This application claims priority of European Patent Office Application No. 08012544.6 EP filed Jul. 10, 2008, which is incorporated by reference herein in its entirety.

### FIELD OF INVENTION

The invention relates to a method for exception handling in a computer program written in a graphical programming language.

### BACKGROUND OF INVENTION

Computer programs, for example for operating a programmable logic controller of an automation system, are defined using programming languages. The program text (also referred to as source code) produced here is then compiled into an assembler code which can be executed by the target system. This can be carried out directly or via a plurality of intermediate stages.

The programming languages which are usually used are subdivided into textual and graphical programming languages. Known examples of textual programming languages are C++, Delphi, Java, C#, Ruby, Python, Eiffel and many others.

A main feature of graphical programming languages is that the programmer “draws” the programs.

Graphical programming languages are being used more and more as a result of the spreading UML (Unified Modeling Language) tools and the code generators contained therein. Examples of these are G (LabView from National Instruments), KOP (ladder diagram according to IEC61131), FUP (function chart according to IEC61131), flowcharts and Petri nets. The European standard EN 61131 which is based on the international standard IEC 61131 deals with the principles of programmable logic controllers.

A subgroup of graphical programming languages is based on electrical circuit diagrams according to the use of the programs produced: G, KOP, FUP. The circuit diagrams drawn are then compiled by a compiler into executable assembler code, just like a code produced with the aid of textual programming languages.

The assembler code is executed in the target system step by step but the instructions should also be able to be executed in a parallel manner corresponding to the output circuit diagrams. In a suitable multicore system, the program parts are then actually distributed among the individual computer cores by the compiler and can thus be executed in a parallel manner.

Programs written in a textual programming language comprise so-called statements which can be understood as meaning, for example, function calls, assignments and also program control structures.

The graphical programming languages based on electrical circuit diagrams comprise “components” (which assume the role of function calls, procedures, subprograms) and “wires” (assignments). Although program control structures are also possible and present in graphical programming languages, they are rather untypical.

Nowadays, programs are almost always created by a plurality of people, in particular in the professional environment. For this purpose, the problem to be solved is broken down into a plurality of parts, and the functions with associated interfaces are produced from these parts. These problem elements are then processed by the individual people, and functions which already exist may be reused in this case as far as possible.

### SUMMARY OF INVENTION

An important aspect when creating software is exception or error handling. Errors may be incorporated when creating the program, for example the incorrect call of functions. The program then either continues to operate incorrectly or is anomalously terminated by the operating system. In order to prevent this, a lot of programming effort is expended in order to test the plausibility of the function parameters and to provide routines which pick up the errors. Furthermore, error values may be returned so that a helpful error message can be displayed, for example, for the user at the operator interface or the developer during testing.

Structured exception handling has become established in textual programming languages. Sometimes even separate keywords have been defined for this purpose: try, catch/except, finally, rise/throw.

One example in C++ is then as follows:

```
try {
  do_this( );
  do_that( );
} catch (std::invalid_argument &e) {
  wail( );
} catch (std::range_error &e) {
  howl( );
} catch (...) {
  std::cerr << “other exception” << std::endl;
};
```

“Do_this( )” is carried out first. If something goes wrong inside the function, it is aborted and “do_that( )” is not carried out. However, if “do_this” went smoothly, “do_that( )” is carried out. If an error has occurred, an attempt can be made to find out what the error was using an error object. In a “catch” block, an attempt can then be made to pick up errors which have occurred. In any case, a block labeled “finally” in which corrections can be made would run. Exceptions which occur outside the “try” and “catch” block are handled by the surrounding structure. If the programmer himself has not carried out any further structuring, the runtime system of the corresponding programming language always remains as the last entity and finally the operating system. All errors which have occurred are thus picked up in one way or another.

The advantage of structured exception handling for the programmer is that the latter, to start with, creates the program routine for processing the actual task. If no exceptions occur, the programmer does not have to expend any further effort since all program parts must be created and tested.

If exceptions occur, the system will be busy investigating the call stack and producing error objects. Structured exception handling should therefore be used only when the occurrence of exceptions is unlikely.

KOP and FUP programs are subdivided into networks. In this case, the standard does not specify any execution order of the components inside a network. A highly optimized compiler could thus replace the entire network with a massively parallel processing step. Boolean combinations can be represented by tables (truth tables), the networks can be mapped to tables, the tables are already fixed at the time of compiling: more complicated statements can be composed from simpler statements in propositional logic and boolean algebra with the aid of the logic combinations. In this case, the truth value of the composed statement must be clearly determined by the truth values of the simpler statements included, for example by a truth table. A truth table is the definition of a logic combination. A plurality of input signals (1, 2, 3 or more) are combined, by means of logic combination, to form an output signal (even 2 or more output signals are possible). The logic combination defines the laws and logical relationships between the input signal and the output signal.

The standard IEC61131 defines only that the networks are processed in succession. Calculations for a preceding network are thus available to subsequent networks. Division into networks is thus also used to segment the problem to be solved into parts which are easier to comprehend.

Since the procedure described above presupposes sequential processing, structured exception handling cannot be used in the case of graphical programming languages which allow calls to be processed in a parallel manner.

An object of the invention is to specify a method for exception handling in graphical programming languages.

This object is achieved by means of a method and a program network as claimed in the independent claims.

At least one error program element (box) comprising an input (IN) and an output (OUT) and an item of exception information stored for exception handling in the form of a data structure are defined for the method for exception handling in a graphical programming language.

In this case, the data structure provides information relating to the exception which has occurred. The type of exception information depends in this case on the hardware system on which the programming is based. However, it is possible to state which information should be universally provided.

Advantageous refinements and developments are specified in the dependent claims.

The error box provides information relating to an exception. The user can use this information to respond to the exception in a suitable form. However, the user requires additional aids for this purpose, for example in order to identify the network in which the exception has occurred.

One example of a data structure for KOP and FUP is as follows:

| typedef structure error | | |
|---|---|---|
| enum id; | // | event id's |
| enum reaction; | // | 0 == ignore, |
| | | 1 == substitute, |
| | | 2 == skip |
| enum mode; | // | addressing mode direct, indirect |
| typedef structure code_address | | |
| enum block_type; | | // OB, FB, FC |
| uint block_number; | | |
| udint address; | | |
| end | | |
| typedef structure data_address | | |
| byte width; | // | bit, byte, word, dword, lword |
| byte type; | // | bool, char, int, sint |
| enum area; | // | I Q M DB SLOT |

| | |
|---|---|
| uint db_number; | // or slot |
| udint instruction; | |
| end | |
| end | |

The data structure should advantageously contain at least one of the following items of information
type of exception,
location of exception,
operand involved in the exception,
type of addressing.

The error ID (id) is an enumeration of all errors defined in the system. It may conceal, for example, the following events (list not conclusive):
the value is outside the range, the access rights are not sufficient, or an attempt is made to access a data address which does not exist.

The statement of the type of addressing (mode) facilitates interpretation of the data address. The data address is generally from the Union data structure. In the case of direct access, it reproduces the address thereof, for example MW60000 or DB5.DBD1000. In the case of indirect access, it may be that either the pointer used for access has not been defined or the offset used addresses beyond the permitted range. In the second case, the incorrect address attempted is stated and, in the other case, the pointer itself must be stated. The precise definition of the data address must always take into account the special circumstances of the target system.

It is clear to the user that the program network is mapped to assembler instructions of the target system but the user never sees the code addresses. In order to thus identify a program network, the “UDINT” of the instruction does not use anything. The user knows the network number, the network name and jump labels.

However, the network number is easily changed and network names are difficult to interrogate.

An advantageous extension of the in-range box and of the comparisons can be used to use jump labels and the “UDINT” of the instruction as operands. The KOP/FUP compiler can in turn form code addresses from the jump labels. These comparisons are quite normal “UDINT” comparisons for the target system but, for the user, it looks as if he is comparing jump labels with one another.

The error response (reaction) defines the response to the exception which has been determined.

On account of the possible parallel execution of the code in a program network, it is not easy to determine which program part is executed first and which program parts had not yet been run through in the event of an exception occurring. Three initial responses are therefore defined on the basis of the exception.

The simplest option is to ignore the problem. If, for example, the intention is to write to a non-existent address such as M60000.0, this does not have any effect on the rest of the network.

If necessary, there is a circumvention option. If, for example, the intention is to read from a non-existent address such as I60000.0, the process can continue to operate with a replacement value.

If the prerequisites for executing the program code of a network are missing, the network must be skipped. If, for example, a method of an object which has been transferred to the module is intended to be carried out, but the pointer to this object is ZERO. Such situations can be checked by the compiler in advance and the user does not need to insert anything into his network for this purpose.

From the point of view of the user, the program code of the network was either executed or not executed. If an exception has occurred inside the network which has been executed, information relating to this is stored and the process continues to run through the rest of the network, if necessary with replacement values (the second option in the case above).

In the case of programs defined in a graphical programming language, a plurality of exceptions may occur on account of the parallel executability. In one embodiment of the invention, the error box can therefore be extended by at least one input which can be used to iterate all exceptions which have occurred. However, it should be taken into consideration in this case that the additional security may be at the expense of the performance of the program.

### BRIEF DESCRIPTION OF THE DRAWINGS

The invention is explained below using an exemplary embodiment, in which

FIG. 1 shows an error program element,

FIG. 2 shows an exemplary network for controlling a motor, and

FIG. 3 shows the associated exception handling.

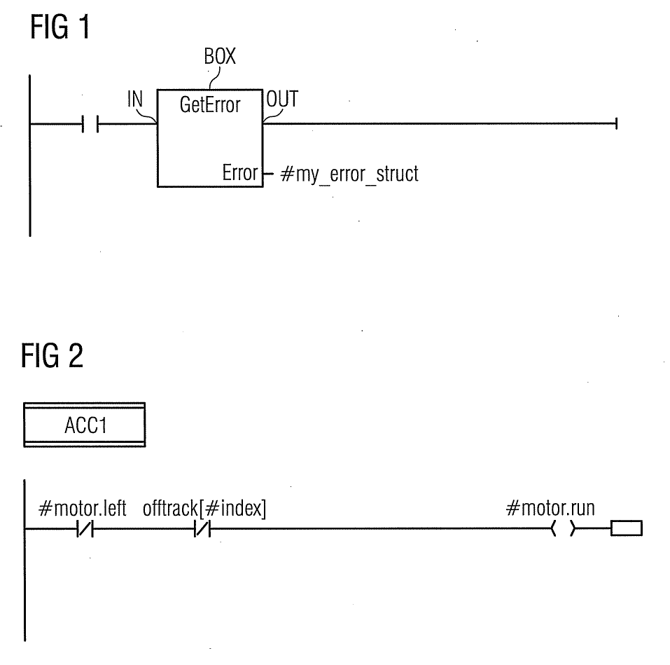

### DETAILED DESCRIPTION OF INVENTION

The visible element in structured exception handling in graphical programming languages is the error program element BOX (also referred to as error box). The error box has an (EN) input IN and an (ENO) output corresponding to the boxes in KOP or FUP according to the standard. The box also has an output for the error structure #my_error_struct described above.

If the input value IN of the error box is TRUE (that is to say an exception has occurred), the information stored in the exception is first made available to the user and this information is then reset again.

If the input value IN is TRUE and an item of exception information is present, that is to say an exception has occurred in one of the preceding networks, the output value OUT of the error box will also assume the value TRUE. The exception information is then copied to an error structure and is available to the user for further evaluation. The exception information itself is then reset.

In order to now implement exception handling in a program in a graphical programming language such as KOP or FUP, an additional network with an error box is inserted after the network to be dealt with. This box is advantageously connected to the program run directly but may also have a preceding logic operation.

It is not necessary to implement exception handling after each network. The first exception which occurs is stored and is provided by the error box. The error box then resets the memory again. Subsequent networks can thus store exceptions which occur afresh. These functions in a similar manner to the “try” block in programs in textual languages where the occurrence of the first exception skips all further statements in the “try” block.

FIG. 2 graphically illustrates, as an example, a program for controlling a motor, for example in an automation environment. ACC1 is the jump label of the program network. The user has a program network in which a transferred parameter #index is intended to be read from the field offtrack. It must now be checked whether #index is smaller than the size of the field. The compiler can automatically integrate this check in the assembler instructions but the graphical programming language according to IEC61131 originally does not provide any means for determining the behavior of exception handling.

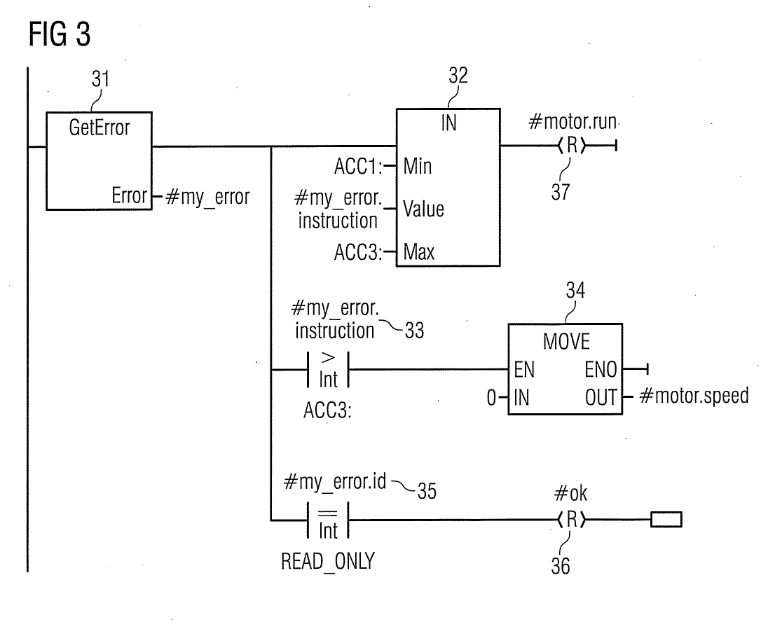

FIG. 3 now shows an example of exception handling according to the method according to the invention.

The error box GetError 31 provides the information stored for the exception in a #my_error structure locally created by the user in the module. If an exception has not occurred, the rest of the network shown remains ineffective according to the (KOP/FUP) rules.

Otherwise, three things are controlled in a parallel manner (by a box having a plurality of inputs 31 according to one embodiment of the invention).

If the exception occurred between the jump labels ACC1 and ACC3, the value #motor.run is reset <R> 37, that is to say the motor to be controlled is switched off.

If, in a second alternative, the exception occurred 33 after the jump label ACC3, the value #motor.speed is set to “0” 34, that is to say the motor speed is reduced to 0. The third alternative checks whether a read-only memory READ_ONLY has been accessed 35; the value #ok is reset <R> 36 in response to this.

1.-11. (canceled)

12. A method of exception handling for a graphical programming language, comprising:
providing at least one error program element including an input and/or an output; and
providing an item of exception information stored for exception handling in form of a data structure.

13. The method as claimed in claim 12, wherein the exception information depends on the hardware system used for programming the exception information.

14. The method as claimed in 12, wherein the data structure includes an item of information selected from the group type of exception, location of exception, operand involved in the exception, type of addressing, and a combination thereof.

15. The method as claimed in claim 12, wherein the data structure defines an exception handling operation selected from the group ignore, circumvent, skip, and a combination thereof.

16. The method as claimed in claim 12, further comprising:
making the exception information available in a first step; and
resetting the exception information in a second step directly after the first step.

17. The method as claimed in claim 12, further comprising:
using a jump label and an associated memory address of an instruction to identify a network affected by an exception.

18. The method as claimed in claim 12, wherein the error program element comprises at least one further input.

19. The method as claimed in claim 12, wherein the graphical programming language is KOP or FUP according to ISO IEC 61131.

20. A program network of a graphical programming language, comprising:
means for exception handling including
at least one error program element having an input and an output, and
an item of exception information stored for exception handling in form of a data structure.

21. The program network of a graphical programming language as claimed in claim 20, wherein the data structure includes an item of information selected from the group type of exception, location of exception, operand involved in the exception, type of addressing, and a combination thereof.

22. The program network of a graphical programming language as claimed in claim 20, wherein the data structure defines an exception handling operation selected from the group ignore, circumvent, skip, and a combination thereof.

23. A computer readable medium storing a method of exception handling for a graphical programming language, the method being executable on a computer system, wherein the method comprises at least one error program element including an input and/or an output and an item of exception information stored for exception handling in form of a data structure.

24. The computer readable medium as claimed in claim 23, wherein the exception information depends on the hardware system used for programming the exception information.

25. The computer readable medium as claimed in claim 23, wherein the data group structure includes an item of information selected from the group type of exception, location of exception, operand involved in the exception, type of addressing, and a combination thereof.

26. The computer readable medium as claimed in claim 23, wherein the data structure defines an exception handling operation selected from the group ignore, circumvent, skip, and a combination thereof.

27. The computer readable medium as claimed in claim 23, wherein the exception information is made available in a first step and is then directly reset in a second step.

28. The computer readable medium as claimed in claim 23, wherein a jump label and a associated memory address of an instruction are used to identify a network affected by an exception.

29. The computer readable medium as claimed in claim 23, wherein the error program element comprises at least one further input.

30. The computer readable medium as claimed in claim 23, wherein the graphical programming language is KOP or FUP according to ISO IEC 61131.
